(19) United States
(12) Patent Application Publication
(10) Pub. No.: US 2011/0039234 A1
(43) Pub. Date: Feb. 17, 2011

(54) METHOD OF TREATING DENTAL PERIAPICAL LESIONS

(75) Inventors: Ronen Huber, Kadima (IL); Joel Aschkenasy, Zurich (CH); Idan Tobias, Beit-Hashmonai (IL)

Correspondence Address: MARTIN D. MOYNIHAN d/b/a PRTSI, INC., P.O. BOX 16446, ARLINGTON, VA, 22215, US

(73) Assignee: Apexum Ltd., Or Yehuda (IL)

(21) Appl. No.: 12/908,896

(22) Filed: Oct. 21, 2010

Related U.S. Application Data
(63) Continuation of application No. 12/083,687, filed on Apr. 17, 2008, now abandoned.
(60) Provisional application No. 60/737,748, filed on Nov. 18, 2005.
(60) Provisional application No. 60/737,747, filed on Nov. 18, 2005.

(51) Int. Cl. A61C 5/02

(52) U.S. Cl. 433/224

(57) ABSTRACT

A method of treating a dental periapical lesion at an apex of a tooth root canal, by accessing the dental periapical lesion via the root canal; and removing the dental periapical lesion via the root canal. In the described preferred embodiments, the dental periapical lesion is accessed via an opening made in the tooth crown leading to the root canal; and the dental periapical lesion is removed by passing a rotary ablating device through the tooth crown, the root canal, and the apex, into engagement with the periapical lesion, rotating the ablating device to ablate the dental periapical lesion, and removing debris produced by the ablation of the periapical lesion via the root canal.

### RELATED APPLICATIONS

This application is a Continuation of U.S. patent application Ser. No. 12/083,687 filed on Apr. 17, 2008, which is a National Phase Patent Application of PCT Patent Application No. PCT/IL2006/001330 having International Filing Date of Nov. 19, 2006, which claims the benefit of U.S. Provisional Patent Application Nos. 60/737,747 and 60/737,748, both filed on Nov. 18, 2005. The contents of the above Applications are all incorporated herein by reference.

### FIELD AND BACKGROUND OF THE INVENTION

The present invention relates to a method of treating dental periapical lesions located at an apex of a root canal of a tooth.

A tooth is composed of a crown and one or more roots which anchor the tooth in a jawbone. The crown, made of enamel and dentin, surrounds a pulp chamber which contains the pulp and extends to the root canal or canals. The root canal opens at the tip of the root (apex) through an opening termed “apical foramen”. A deep cavity, a cracked filling, or a cracked tooth can lead to pulp infection or injury. This in turn can lead to pulp inflammation and infection which may spread to the root canal, often causing sensitivity to hot or cold foods and pain, among other problems. If not treated at this stage the pulp may then become necrotic and infected. Bacteria that exit from the root canal through apical foramen may spread into adjacent or remote tissues. To prevent that, the host mounts an inflammatory response around the apical foramen which results in local bone destruction. The lesion thus formed is commonly termed a “periapical lesion”.

Periapical lesions may also develop when a previous root canal treatment (as detailed below) was unsuccessful in adequately performing its main task of elimination of bacteria or when prior root canal filling and/or coronal restorations are leaking, thus allowing bacteria to re-contaminate the root canal.

Treatment involves removing the diseased, injured or necrotic pulp, or contaminated root canal filling material, cleaning shaping and disinfection of the pulp chamber and root canals, followed by their sealing with a root canal filling which is followed by filling or restoring the crown. Typically, an opening into the pulp chamber is made, generally through the crown and dentine, and the pulp or necrotic/infected tissues, or the infected root canal filling material is removed using an endodontic file. The pulp chamber and root canals are then cleaned, shaped and sealed.

To prevent and/or irradicate infection, an antiseptic, such as calcium hydroxide may be applied to the pulp chamber and root canals before sealing and retained there for a period of about two weeks to disinfect them. The crown opening can be temporarily filled, e.g., with IRM, GC Fuji 9, or Ketamolar, to protect the tooth in order to prevent re-infection of the root canals until the next dental visit, and possibly in order to restore the chewing surface.

Following removal of the temporary filling and antiseptic medication, the pulp chamber and root canals are cleaned and filled with a root canal filling. A permanent filling, such as amalgam, conventional composite or a crown, are then used to restore the chewing surface of the tooth.

Alternatively, after cleaning and reshaping the root canals and applying medication, the root canals can be filled with a root filling material, such as, Gutta Percha or a paste, to an apical point of the root canal. The pulp chamber can then be filled with a temporary filling or a sealing layer. At the next dental visit, the temporary filling, as well as some of the root canal filling are removed, and a post (also referred to as a dowel) is positioned in the pulp chamber and root canal and cemented in place using a dental cement, for example, composite cement, zinc-phosphate cement, or another cement or sealer.

The post may be formed from a metal, such as a dental alloy, from quartz, reinforced carbon fibers, or from another suitable material. The post can be rigid or flexible to some extent. Where two or more root canals are being treated, one or more posts can be used.

The post can be prefabricated and shaped during the procedure. Alternatively, a mold of one of the root canals and remaining tooth and pulp chamber may be taken in the dental clinic and sent to a dental laboratory, to enable a metal cast post to be tailor-made based on the mold.

Generally, the above described treatment procedure is effected by an endodontist who removes the diseased pulp and cleans and seals the pulp chamber and root canals, a prosthodontist who fills or restores the crown, and a dental technician who prepares the restored crown based on a mold prepared by the prosthodontist. Nevertheless, all the above procedures may be, and are commonly carried out, by a dentist who is a general practitioner.

Root canal infection can also lead to formation of lesions (e.g. abscess, granuloma, or radicular cyst) around the root apex (periapical). Periapical lesions are typically treated according to the procedure described above. While such treatment is generally successful and results in healing of the periapical lesion, in cases where the root canal treatment fails, where it cannot be accessed, or where it is desired to accelerate healing, an apicoectomy surgical procedure is generally used.

Apicoectomy is a procedure in which the root tip is surgically accessed directly through the gums and the jaw bone. The granulation tissue of the periapical lesion is removed, and the root tip is resected, cleaned and sealed through any one of several approaches.

Although widely practiced, apicoectomy is an invasive surgical procedure and as such it is commonly accompanied by postoperative pain, swelling and complications. In addition, it carries a risk of infection and injury to nerves, soft tissue, bone and adjacent teeth. Furthermore, some teeth are less accessible or inaccessible surgically (e.g. palatal roots of upper molar), and as such, this procedure cannot be utilized in some periapical lesions. Finally, this procedure oftentimes results in aesthetic problems such as scarring and recession of gums around restored crown and bridgework.

### OBJECT AND BRIEF SUMMARY OF THE PRESENT INVENTION

An object of the present invention is to provide a method of treating dental periapical lesions having advantages over the known methods in one or more of the above respects.

According to a broad aspect of the present invention, there is provided a method of treating a dental periapical lesion at an apex of a root canal of a tooth, comprising: accessing the dental periapical lesion via the root canal; and removing the dental periapical lesion via the root canal.

As will be described more particularly below, since the method of the present invention does not involve cutting through the gums and the jawbone of the patient, it avoids many of the drawbacks of the existing techniques for removing dental periapical lesions, including post operative pain, swelling, possible complications, and risk of infection or injury to nerves, soft tissue, bone and adjacent teeth. In addition, the method of the present invention can be utilized for virtually all dental periapical lesions, even those in teeth which are less accessible using conventional surgical procedures.

As used herein, the phrase “periapical lesion” refers to lesions of endodontic origins, including granulomas with or without cystic lesions, which typically surround the root apex; and the term “periapical tissue” refers to tissue (such as jaw bone tissue) which surrounds the tip of the root.

Several approaches can be used to access osseous tissue through the root canals. One preferred approach starts with the hollowing out of the pulp chamber and root canals using conventional prior art procedures and devices (e.g. drills and endodontic files). Once the tooth is hollowed out, the root canals can be accessed and the lesion tissue surrounding an apex of the root canal can be removed or resected. Such resection can be effected via any one of several devices. Suitable devices include, but are not limited to, a rotary endodontic file, a high speed rotating biodegradable ablating filament, or a low speed rotating shape-memory metal ablating filament. Alternatively, thermal devices, such as a diathermy device (e.g. diathermy pencils), liquid nitrogen, laser or ultraviolet light emitting devices can also be used.

Devices utilizing rotary resecting or ablating filaments are presently preferred. Such devices enable controlled resection or ablation of lesion tissue without damaging surrounding healthy tissues. For example, a high speed rotating biocompatible or biodegradable polymeric filament, composed of, for example, polydioxanone, polylactic acid (PLA) or polyglycolic acid (PGA), can be attached to a dental drill head and inserted via an opening made in the tooth crown into the root canal. When rotated at high speed, the centrifugal force forces the end of the filament to angle outwardly of the filament axis, and to grind away, or ablate, the tissue. An alloy filament made, for example, from Nickel-Titanium (NiTi) can also be used at lower speeds. The alloy can be a pre-shaped shape-memory alloy that has an austenitic final (Af) transition temperature less than body temperature (e.g. 25° C.). Thus, at body temperature, the alloy filament will transition into the austenitic phase and curve outwardly to a predetermined shape such that, when rotated, it will grind and resect or ablate the soft tissue of the lesion, without damaging the surrounding bone tissue.

Ablation of lesion tissue can be accompanied by resection of the root tip. Such root tip resection is advantageous in that it removes a potential source of infection (e.g. bacteria) present in branches of the main root canal and in the microscopic side canals (dentinal tubules) branching from the main root canal. Resection of the root tip is also advantageous in that it promotes healing.

Once the lesion, and optionally the root tip tissue, are resected, finely ground or minced debris are removed by rinsing and aspiration using devices such as suction devices known in the art of dentistry, or alternatively, by backflow, when applying pressurized rinsing using devices such as a normal syringe with a needle thinner than the apical foramen. The root is then cleaned and prepared for sealing.

Prior to root sealing, compositions which include bone growth factors [e.g. Bone Morphogenic Proteins (BMP)] or substances (e.g. Tri calcium phosphate TCP, hydroxyappetite HA), and/or antiseptic substances such as, antibiotics and chlorexidine, can be administered into the space formed by removal of lesion tissue.

In one described preferred embodiment, the removal of the dental periapical lesion comprises an initial step in which a first ablating device having a metal filament, rotated at low speed is used to roughly mince the dental periapical lesion, and a subsequent step in which a second said ablating device having a polymeric filament, rotated at high speed, is used to further mince the minced dental periapical lesion to a finer particle size.

In the above described preferred embodiment, the sleeve of the first ablating device is fixed to the tooth before the filament of the first ablating device is rotated. The sleeve of the second ablating device is rotated with the filament of the second ablating device.

As indicated earlier, the preferred embodiments of the invention described below utilize rotary ablating devices of the foregoing types for removing the dental periapical lesions in accordance with the present invention. It will be appreciated, however, that many of the advantages of the invention, over the presently used surgical technique of cutting through the gums and the jawbone of a patient, can be attained by other methods of accessing and removing the dental periapical lesion via the root canal.

Further features and advantages of the invention will be apparent from the description below.

### BRIEF DESCRIPTION OF THE DRAWINGS

The invention is herein described, by way of example only, with reference to the accompanying drawings, wherein:

FIGS. 1 and 2 illustrate two forms of ablating devices constructed in accordance with the present invention;

FIGS. 3a-3m illustrate various stages in one procedure involving the use of the ablating device of FIG. 1 for removing a dental periapical lesion;

FIG. 4a illustrates a modification in the metal filament ablating device of FIG. 1;

FIGS. 4b and 4c are side elevational views, and FIG. 4d is a top plan view, of the ablating device of FIG. 4a;

FIG. 5 illustrates another polymer-filament ablating device constructed in accordance with the present invention;

FIGS. 6a-6d are views, corresponding to those of FIGS. 4a-4d illustrating another metal-filament ablating device constructed in accordance with the invention;

FIG. 7 illustrates the manner in which the ablating device of FIGS. 6a-6d is used for removing a dental periapical lesion;

FIG. 8 illustrates a protective cover used in one step of another procedure as illustrated in FIGS. 10a-10k;

FIG. 9 illustrates the manner in which the protective cover of FIG. 8 is used in the procedure of FIGS. 10a-10k;

FIGS. 10a-10k illustrate various stages in another procedure involving the use of both ablating devices for removing a dental periapical lesion;

It is to be understood that the foregoing drawings, and the description below, are provided primarily for purposes of facilitating understanding the conceptual aspects of the invention and possible embodiments thereof, including what is presently considered to be a preferred embodiment. In the interest of clarity and brevity, no attempt is made to provide more details than necessary to enable one skilled in the art, using routine skill and design, to understand and practice the described invention. It is to be further understood that the embodiments described are for purposes of example only, and that the invention is capable of being embodied in other forms and applications than described herein.

### DESCRIPTION OF PREFERRED EMBODIMENTS

As indicated earlier, the present invention provides apparatus particularly useful for removing dental periapical lesions at an apex of a root of a tooth. For this purpose, the apparatus provides a rotatable ablating device sized and constructed for (a) introduction through a cavity in the tooth into the root canal; (b) movement therethrough to protrude through the apical foramen into contact with the dental periapical lesion; and (c) rotation while in contact with the dental periapical lesion in order to mince the lesion by ablation so that the particles may be removed via the apical foramen.

While the invention is particularly useful for removing dental periapical lesions, it can also be used in a wide range of laparoscopic procedures, as well as less invasive subcutaneous and endoscopic procedures. The terms “laparoscopic” and “endoscopic” are interchangeably used herein to refer to surgical procedures performed through small, natural or artificially created openings or portals in the body (e.g. arthroscopic, endoscopic, laparoscopic, hysteroscopic, thoracoscopic). The apparatus of the present invention may be used in such procedures in conjunction with a camera or other imaging devices (e.g. X-ray, MRI, ultrasound) which enables the physician to view the work site during the procedure.

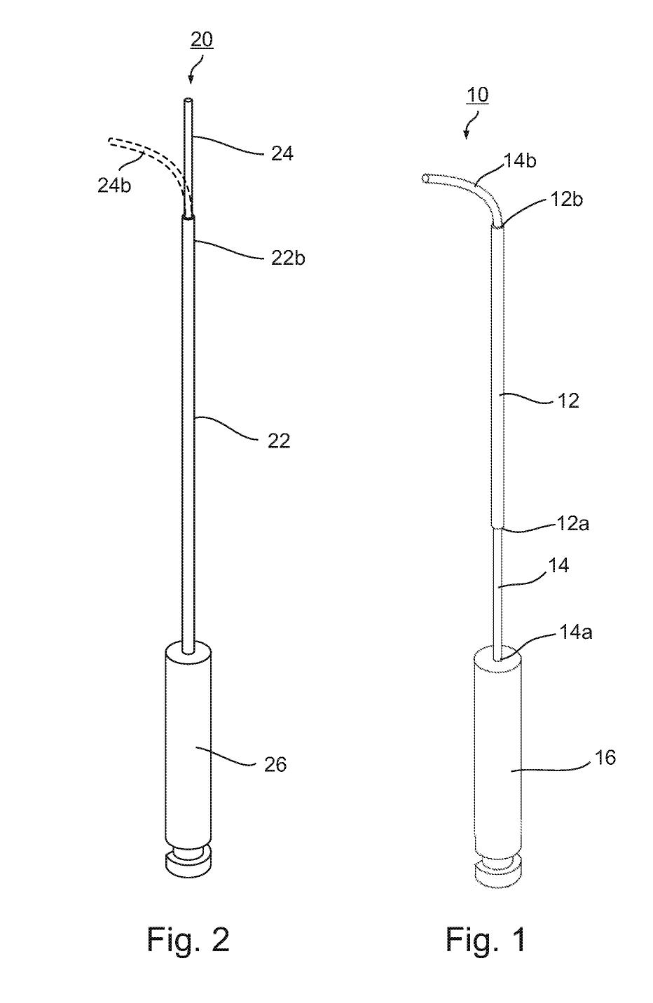

FIG. 1 illustrates one form of rotatable ablating device particularly useful in apparatus constructed in accordance with the present invention for removing dental periapical lesions. The ablating device 10 illustrated in FIG. 1 includes a sleeve 12 sized and constructed for introduction via a cavity in the tooth (e.g., a cavity drilled through the crown of the tooth) into the tooth root canal, and for movement therethrough to the apex of the root canal, as will be described more particularly below. Sleeve 12 includes a proximal end 12a and a distal end 12b. The latter end is to be located at the apex of the root canal having the dental periapical lesion to be removed.

The ablating device illustrated in FIG. 1 further includes a filament 14, also having a proximal end 14a and a distal end 14b. As shown in FIG. 1, distal end 14b of filament 14 protrudes outwardly of distal end 12b of sleeve 12. Its protruding end is formed with a curvature, curving away from the longitudinal axis of the filament and of the sleeve. As will be described more particularly below, the protruding outwardly-curved end 14b of filament 14 is brought into contact with the dental periapical lesion to be removed such that rotation of the filament ablates the dental periapical lesion.

The proximal end 14a of filament 14 is fixed to a shank 16 which may have an annular recess 18 to facilitate coupling the filament to a rotary drive, or be coupled using friction. In the ablating device illustrated in FIG. 1, filament 14 is rotatable and axially-displaceable with respect to sleeve 12.

Sleeve 12 is fabricated from a polymer, such Nylon, Pebax or Teflon, or a metal, such as stainless steel or a super elastic alloy, such as super elastic Nitinol™. Preferably, it has a length of about 12-40 mm, an external diameter of about 0.25-0.9 mm, and an internal diameter of about 0.20-0.80 mm.

It will be appreciated that although sleeve 12 is illustrated as having a single lumen, a configuration having two or more separate lumens may also be used. Such a multi-lumen sleeve configuration can be used for aspiration, drug delivery, or fiber optic imaging. The sleeve may also have scales for measuring the depth of penetration, and an anchoring mechanism (e.g. screw tip, oxidized section) for anchoring sleeve 12 to a tissue (e.g. bone).

Filament 14 may also be fabricated from a polymer, such as Poly-p-dioxanone, polylactyc acid or polyglycolic acid, or an alloy such as shape memory alloy Nitinol™. It preferably has a length of about 25-50 mm, and an external diameter of about 0.25-0.80 mm. Filament 14 can be solid or hollow; if hollow, an internal diameter of about 0.1-0.7 mm is preferred. Filament 14 may be fabricated from a radio-opaque material, but if not, at least one radio-opaque marker can be added to the filament at equal intervals to allow for X-ray location.

The outwardly-curved end portion 14b of filament 14 is typically 5-20% of the filament length. It may be fabricated from the same material as the remainder of the filament, or from a different material (e.g. different hardness, elasticity, etc). Since end portion 14b is mechanically stressed by the rotary motion and by contact with body tissue, if fabricated from a polymer it is preferably fabricated from a biocompatible or bioresorbable polymer such that any fragments resulting from its disintegration are resorbed by the body.

End portion 14b can be fabricated in a round, square, triangular, flat, star or any other cross-sectional shape suitable for tissue resection or grinding. This end portion is preferably designed to angle or form a predetermined shape where protruding from the sleeve distal end 12b when positioned within the body. This can be achieved by fabricating filament 14, or portion 14b thereof, from a shape memory polymer or alloy (e.g. Nitinol™) which is straight at room temperature and angles to produce a curved portion 14b when placed under temperatures higher than its transformation temperature (e.g. body temperature). If it is a superelastic alloy of Nitinol, it can be forced to a straight shape by the sleeve, when inserted into it.

The extent of angling of portion 14b, its composition, and the cross-sectional shape thereof, are determined according to the tissue to be ablated.

As indicated earlier, filament 14 in the ablating device illustrated in FIG. 1 is both rotatably and axially displaceable with respect to sleeve 12. FIG. 2 illustrates an ablating device, therein generally designated 20, also including a sleeve 22 enclosing a filament 24, with the distal end 24b of the filament projecting from the distal end 22b of the sleeve. In this case, however, both the filament 24 and the sleeve 22 are secured to adaptor 26, such that both the sleeve and filament rotate together with the adaptor. In fabricating such an ablating device, the filament 24 may be passed through the sleeve 22 until the distal end 24b of the filament projects through the distal end 22b of the sleeve to produce the desired curved end portion of the filament, and then the adaptor 26 may be crimped to bind the sleeve and filament to the adaptor, such that the sleeve rotates with the filament.

The FIG. 2 construction is particularly useful where both the filament and the sleeve are made of a polymer. The constructions and dimensions of the protruding end 24b of the filament may be such that it assumes the curved configuration (shown in broken lines in FIG. 2) by centrifugal force upon the rotation of the filament.

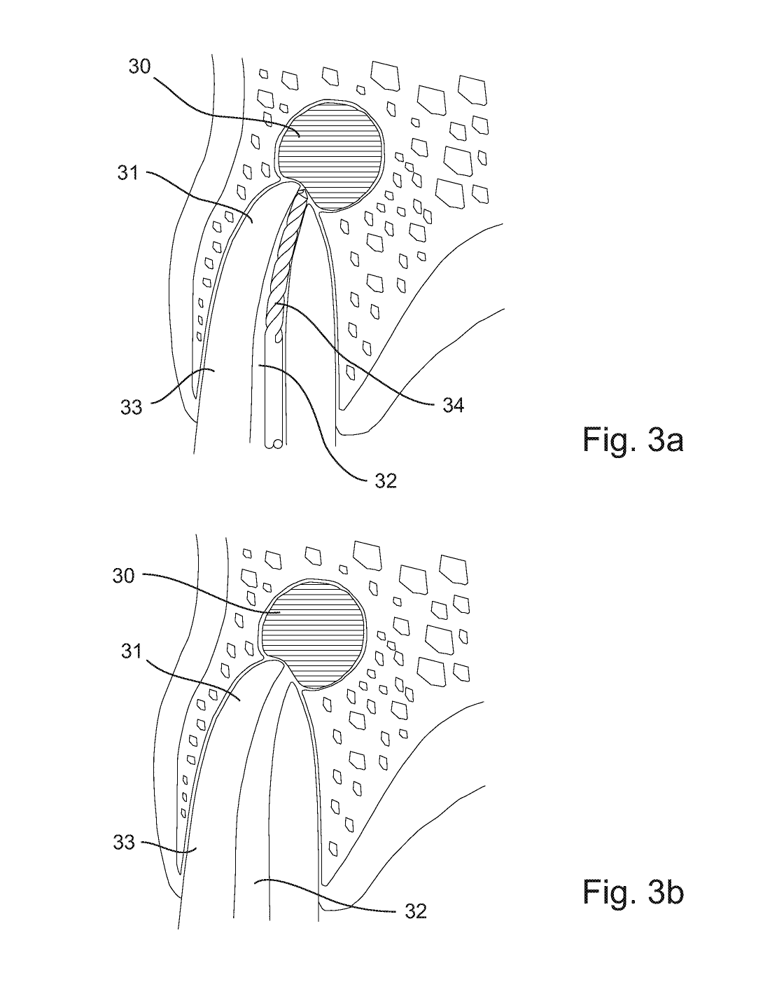

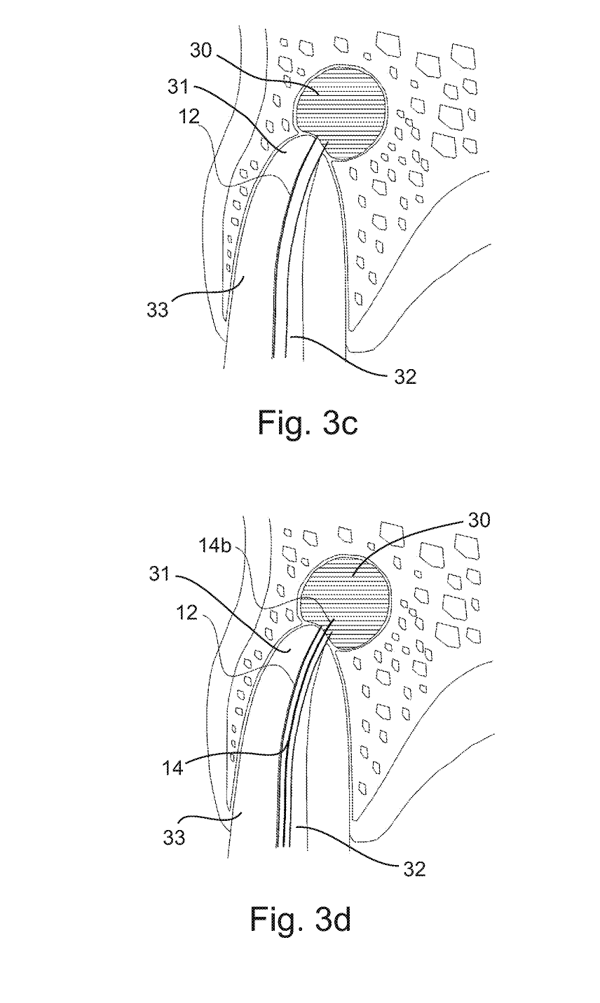

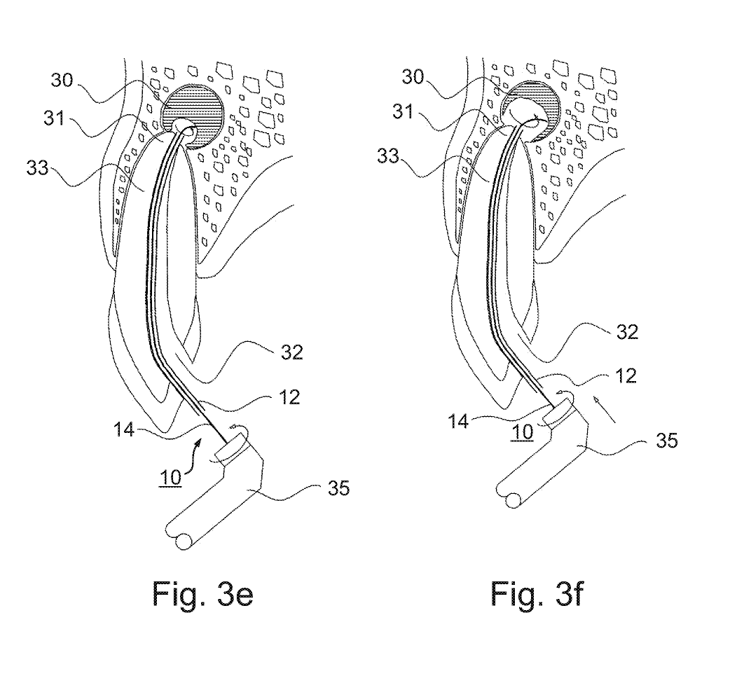

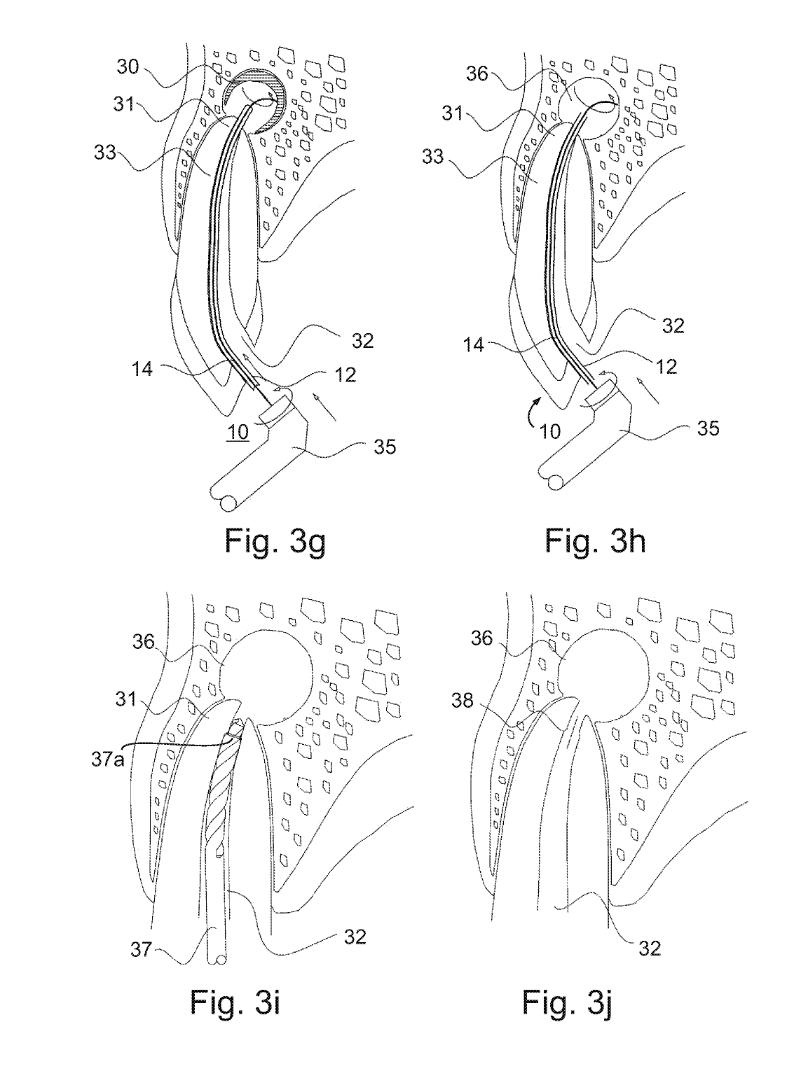

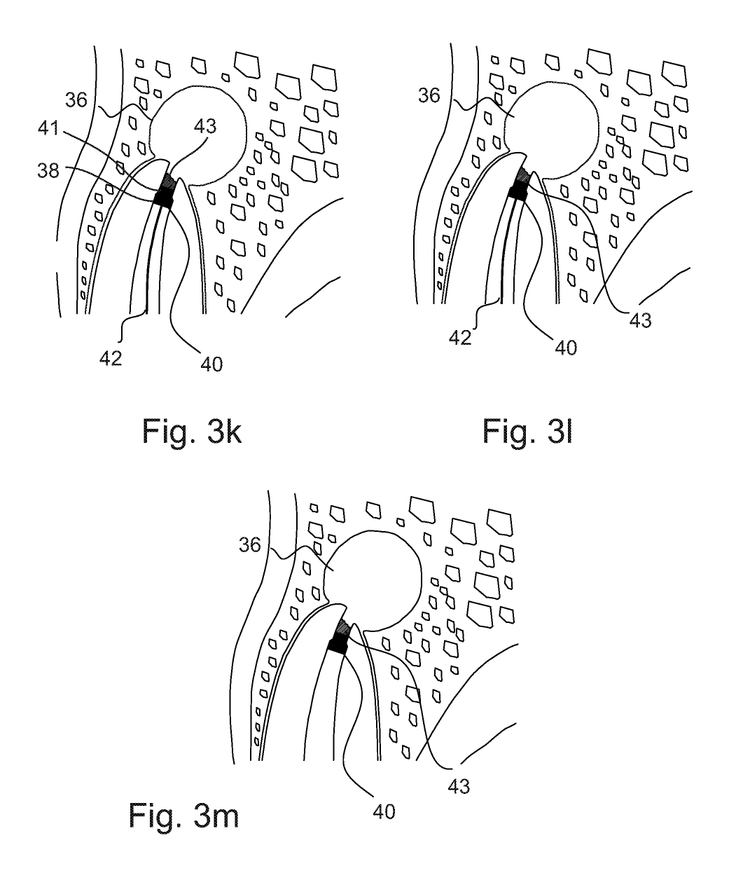

FIGS. 3a-3m illustrate one manner of using the ablating device 10 of FIG. 1 (or 20 of FIG. 2) for the removal of a dental periapical lesion, schematically illustrated at 30 in those figures, located at the apex 31a of a canal 32 formed in a tooth root 33.

Following a standard pulp chamber access and pulp removal, or removal of infected root canal filling material from a prior failing treatment, the root canal is cleansed using files and liquid to remove all traces of pulp debris, bacteria or root canal filling material and the like. The apical foramen of root canal 32 is then reshaped and enlarged, using a file 34 to an ISO size of 40-120 (0.4-1.2 mm), preferably size 60 (0.6 mm), as shown in FIGS. 3a, 3b.

Following reshaping of the apical end of the root canal 32, the ablating device 10 of FIG. 1 is then utilized for lesion removal. Sleeve 12 is first inserted into the reshaped root canal 32 to a working length (end of apex 31a), and filament 14 is then inserted through sleeve and into lesion 30, such that distal end portion 14b of the filament protrudes from the distal end of sleeve 12 (FIGS. 3c, 3d).

When utilized for apical lesion removal, sleeve 12 and filament 14 can be fabricated from a polymer or a metal (e.g. polymers such as nylon, PGA, PLA, or metal alloys such as Nitinol™). Filament 14 may have any desired cross sectional shape (e.g., round, elliptical, flat, star-like, etc). If round, it preferably has a typical cross sectional diameter of 0.1-0.5 mm and a length of 20-40 mm. Filament 14 can be solid or hollow and selected of any suitable Shore hardness (typically Shore hardness range A 10-90). A hollow configuration is preferred in cases where provision of medication, such as a local anesthetic or a rinsing fluid, is required, although such rinsing or medication provision, as well as suction, can also be effected through a lumen in sleeve 12, or through a space formed between sleeve 12 and filament 14.

The ablating device 10 is then connected to an electrical or pneumatic drill head (dental handpiece) 35 (FIG. 3e), e.g. KAVO GentleSilence 8000, KAVO intramatic E or Morita triautozx. Filament 14 is rotated within sleeve 12, first at a low speed (several hundred rpm) to enable initial ablation of granulation tissue surrounding the root apex 31a (FIG. 3e). The rotational speed of filament 14 is then gradually increased (up to 50,000 rpm), and both filament and sleeve are advanced (FIGS. 3e-3h) in the direction of the lesion with an in-and-out motion, to enable three dimensional fine grinding of the tissues of the surrounding lesion 30.

Throughout the procedure, a liquid such as water or saline solution may be utilized to wash the ground tissue, to assist in grinding, and to prevent overheating. Rinsing and suction can be conducted through filament 14, if hollow: alternatively filament 14 can be periodically removed, and rinsing/suction can be conducted through the sleeve. As a still further alternative, rinsing/suction can be conducted through a space between sleeve 12 and filament 14.

To enable three dimensional grinding and complete removal of lesion 30, the ablating device utilizes a filament 14 which angles when protruding through its sleeve 12. Such angling can be controlled by the amount of filament protruding from the sleeve and by the rotational speed used. Alternatively, the filament, or at least its end portion, can be made of a material (e.g., Nitinol™) which is capable of angling, and/or of forming a shape such as a hook or loop when the end portion protrudes from sleeve 12.

The root's apical portion 31a (FIG. 3h) can also be resected or ablated by using a filament 14 having a blade-like end portion 14b which curves back to form a hook once it protrudes from sleeve 12. Rotating this blade against apical portion 31 will grind it off and thus remove side canals which are a potential source of infection. Such root apex resection tends to improve healing and to reduce the chances of re-infection.

During or following the above-described ablation procedure, an X-ray procedure can be used, by the addition of a radio-opaque guide positioned on filament 14 or injected therethrough, to provide the dentist with information regarding the size of the periapical lesion and the extent of its removal. It can also provide a reference point for monitoring the healing phase.

In any case, once lesion 30 and surrounding tissue are removed, the ablation device is removed, the lesion space and root canal are thoroughly rinsed and the root canal 32 is sealed (e.g. by using gutta percha and cement), and the crown is restored. The procedure may be carried out as a one-visit procedure or as a multiple-visit one. In case of a one-visit procedure all the above steps may be carried out. In case of a multi-visit procedure the initial stage of cleaning, shaping and disinfection of the infected root canal or removal of prior root canal filling, may be carried out in the first visit, followed by placement of a medicament (e.g. an antiseptic or inflammatory response modifier) in the root canal to be retained there until the second visit, when the periapical ablation procedure will be carried out, followed by a root canal filling.

As another alternative, after lesion 30 and surrounding tissue have been removed, various substances may be injected into the periapical space 36 (FIG. 3h) through the sleeve 12 or hollow filament 14, in order to disinfect the region and accelerate bone growth/regeneration.

In this example, after lesion 30 with its tissue has been removed, a drill 37 (FIG. 3i), formed with a step or shoulder 37a is utilized to create a step or shoulder shown in FIG. 3j at 38 approximately 1 mm from the tip. This reshaping is effected such that the canal preferably tapers in a stepwise fashion towards the root apex 31.

A prefabricated plug 40 having a shoulder 41a (FIGS. 3k-3m) is then positioned via a guide 42 against shoulder 38. Plug 40 can be composed of mineral trioxide aggregate (MTA), Titanium, Nitinol™, gutta percha, composite material, girconium, or any combination thereof and may be cemented therein, as shown at 43 (FIG. 31). Following plug positioning and its permanent cementation, guide 42 may be detached from plug 40 (FIG. 3m), and the root canal 32 is then obturated via conventional methods.

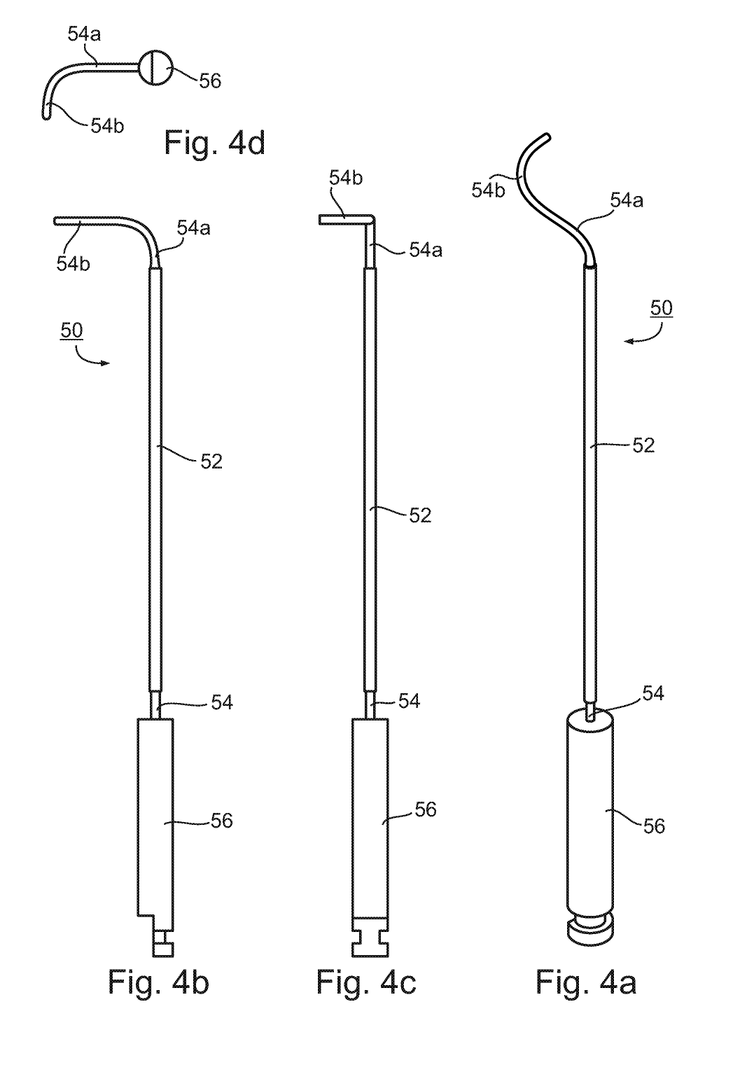

The above-described procedure illustrates the use of a single ablating device, such as 10 of FIG. 1 or 20 of FIG. 2, for removing a dental periapical lesion at the apex of a root of a tooth. FIGS. 4a-10k illustrate the use of two such ablating devices in a two-step procedure for removing a dental periapical lesion at the apex of a root of a tooth, or for other applications involving removing or resecting tissue enclosed within a harder tissue, typically a diseased/infected/inflamed bone tissue enclosed within a healthy bone tissue, without damaging the surrounding tissue.

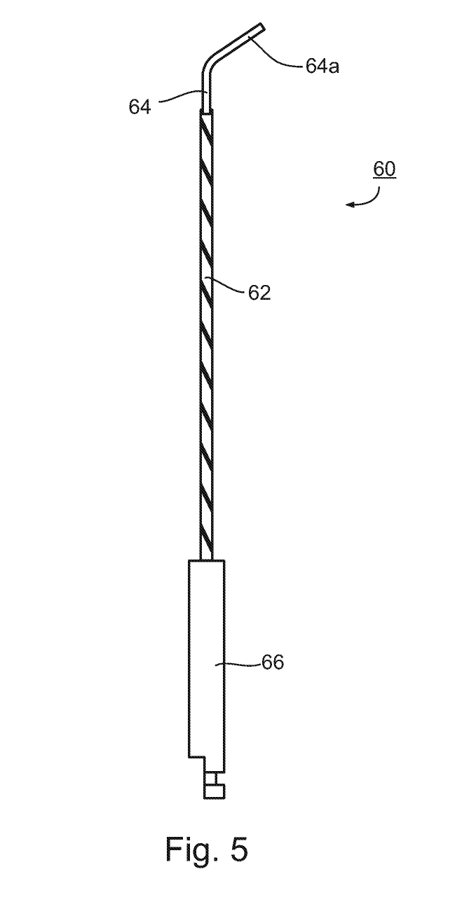

Such a procedure is performed in two consecutive steps: the first step utilizes an ablating device, such as shown at 50 in FIGS. 4a-4d, including a Nitinol superelastic sleeve or sheath 52 enclosing a shape-memory or superelastic Nitinol filament 54; and the second step utilizes an ablating device, as shown at 60 in FIG. 5, including a superelastic Nitinol sleeve or sheath 62 enclosing a filament 64 of an elastic biocompatible or bioresorbable polymer, such as poly-dioxanone, polyglycolic acid or polyactyc acid.

In ablating device 50 (FIGS. 4a-4d) used in the first step, the shape memory Nitinol filament 54 is fixed to the shank 56 connectable to the rotary drive (e.g., 35, FIG. 3e), whereas the superelastic Nitinol sleeve 52 is freely mounted on filament 54 for axial and rotatable movement with respect thereto. The shape memory Nitinol filament 54 has a transformation temperature slightly lower than body temperature (typically 25° C.). When filament 54 is extended out of the constricting sleeve 52 and exposed to body temperature, its distal end assumes a predetermined shape comprising two arcs 54a, 54b which lie on planes orthogonal or at an angle to each other and to the longitudinal axis of sleeve 52. alternatively, the filament may be constructed of a high elasticity or super elasticity material such as super elastic Nitinol™, which is constricted at a straight shape by the sleeve, and accepts its pre-determined shape when release from the sleeve. Filament 54 is preferably of circular cross-section, with a blunt end facing a relatively sharp outer edge. The arcs have a radius of between 0.5-6 mm for various sizes of lesions.

In the first step, the sleeve 52 and the projecting end of the filament 54 are rotated at low to medium speeds, of up to 1000 rpm (typically 30-1000 rpm). This assures that while the projecting end of the filament is extended into the inflamed soft tissue, the sharp edge is pushed forward to allow easy penetration. However, when the filament is fully extended and rotated clockwise, the distal bend 54b presents a blunt edge which is deflected from the hard bone tissue, thereby assuring that the healthy bone tissue is not damaged during the rotation. Ablating device of FIGS. 4a-4d is used in the first step to remove the inflamed tissue and/or to grind or mince the periapical lesion, before utilizing the ablating device 60, including the polymer filament 64, to be inserted for use in the second step in which the lesion is removed.

In ablating device 60 used in the second step of the treatment, both the polymer filament 64, and its sleeve 62, are attached to the adapter 66 so that both rotate together. In this case, ablating device 60 is rotated at a higher speed, over 1,000 rpm (typically 14,000-50,000 rpm). At such speed, the centrifugal forces acting on filament 64 cause it to deflect sideways. Since the polymer filament 64 is relatively soft, it cannot penetrate the inflamed tissue. However, after the tissue has been initially ground by ablating device 50 (FIGS. 4a-4d) utilizing the Nitinol filament 54, the tissue is soft and fragmented enough to allow the penetration of filament 64 of ablating device 60 when the filament is rotated at high speed. Filament 64 thus minces the already ground tissue to very fine particles that may be washed and suctioned out through the apical foramen, as described above. Filament 64 is biocompatible or bioresorbable, which ensures that when the filament wears and tears as a result of brushing against the hard bone tissue, the resulting filament particles will be resorbed by the body in a matter of a few weeks.

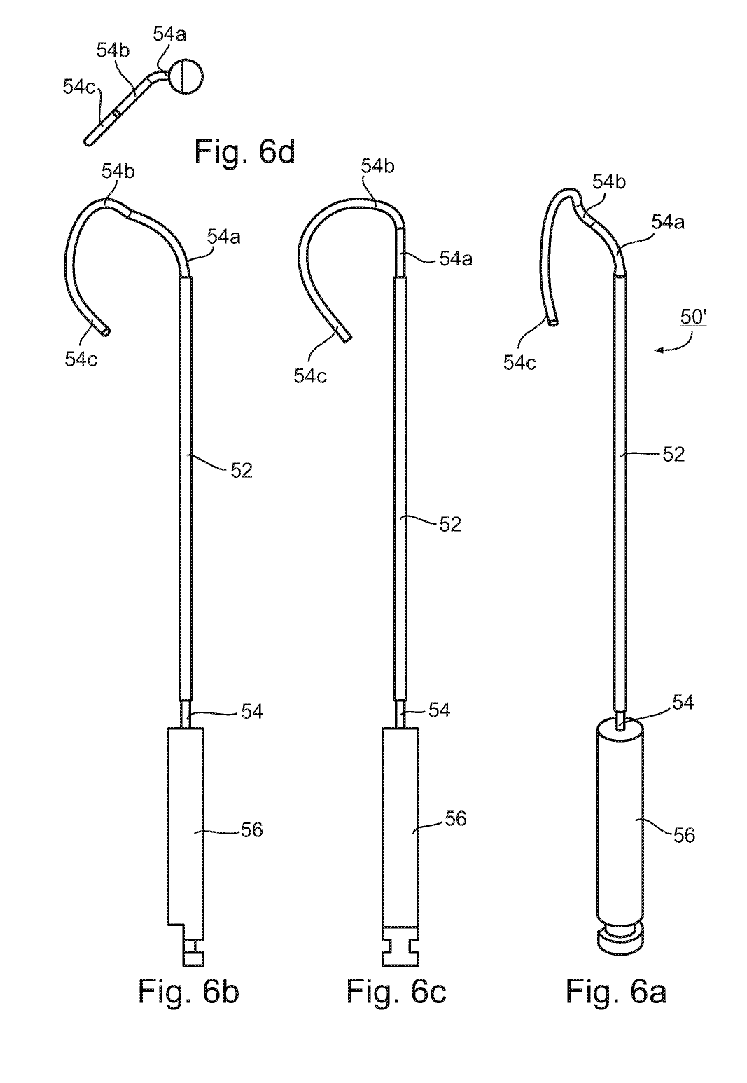

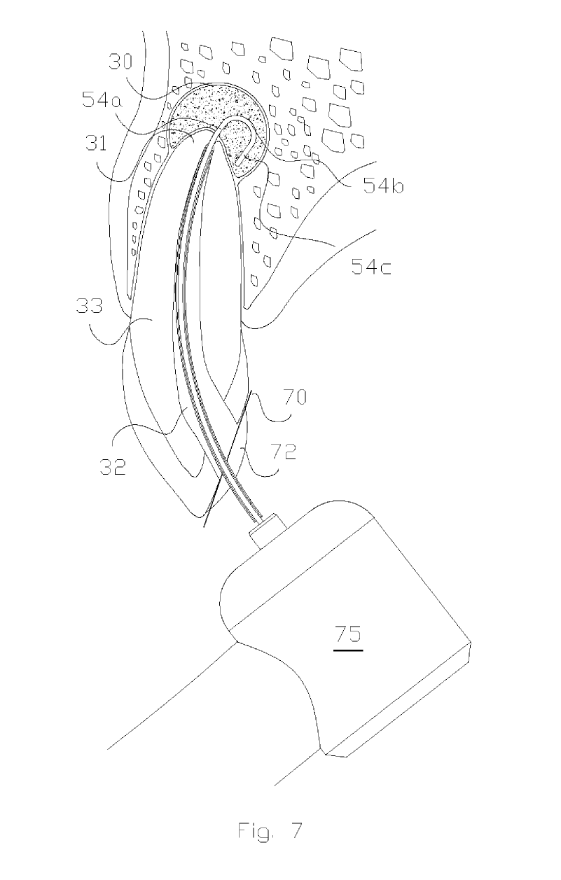

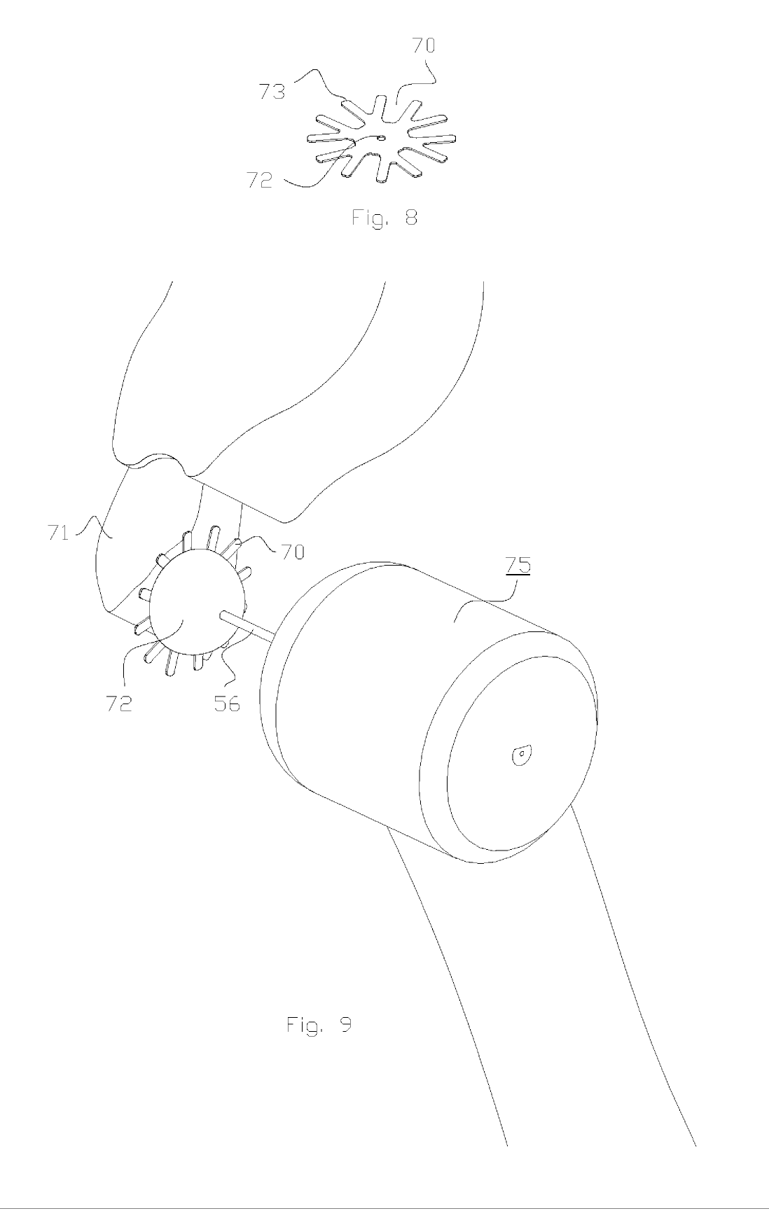

FIGS. 6a-6d illustrate an ablating device, generally designated 50′, of basically the same construction as ablating device 50 of FIGS. 4a-4d, and therefore corresponding parts are identified by the same reference numerals. In ablating device 50′ of FIGS. 6a-6d, however, the Nitinol filament 54 has a third curved section 54c at its distal end, which is of a retrograde configuration, i.e., bent back towards its proximal end. Such a retrograde section of the filament allows reaching parts of the region that surround the tooth apex and which may otherwise be inaccessible to the ablator, as shown in FIG. 7.

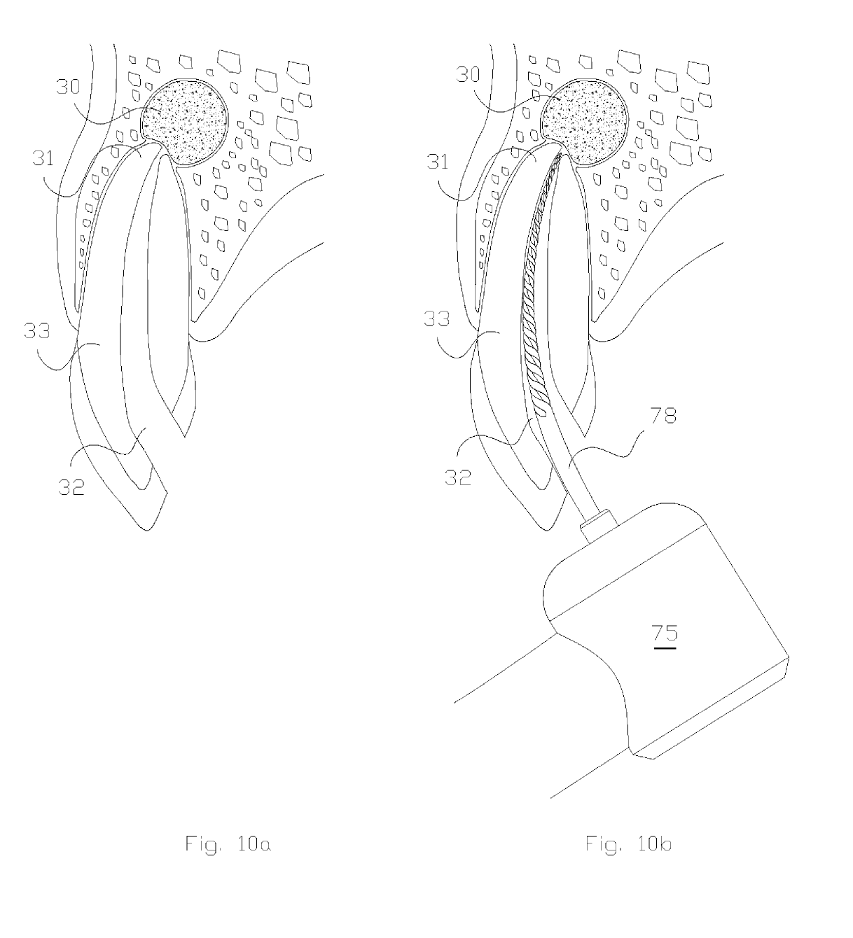

As will be described more particularly below, ablating 50 (or 50′), including the Nitinol filament 54, is used in the first step. When used in the first step, its sleeve 52 is fixed by an adhesive to the tooth and stabilized, before the Nitinol filament 54 is rotated by its adaptor 56. To prevent the adhesive from entering the root canal, a protective cover is used, such as shown at 70 in FIG. 8. Such a protective cover may be made of thin aluminum foil to be placed over the crown of the tooth (71, FIG. 9) to be treated, after an opening has been formed through the crown to provide access to the root canal. The ablating device 50 (or 50′), with the Nitinol filament 54 completely retracted within the sleeve 52, is passed through opening 72 in the protective cover 70 into the root canal of the tooth, and is moved through the root canal to its position at the apex of the root canal. A glob of adhesive 74 is then applied over the protective cover 70 and the sleeve (FIG. 9), such that the adhesive flows between the tabs 73, and thereby binds the protective cover and the sleeve to the tooth. Such an arrangement has been found to firmly hold the sleeve 52 of the ablating device to the tooth, allowing the filament 54 to be advanced through the sleeve into contact with the periapical lesion to be removed, without clogging the root canal by the adhesive.

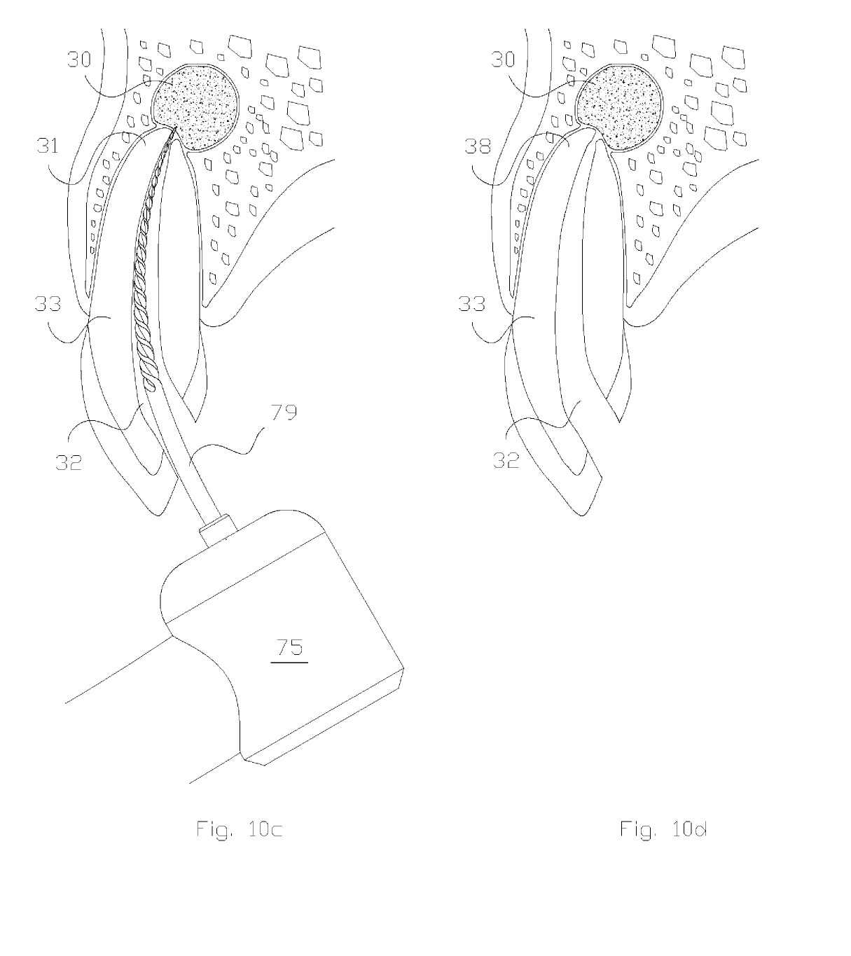

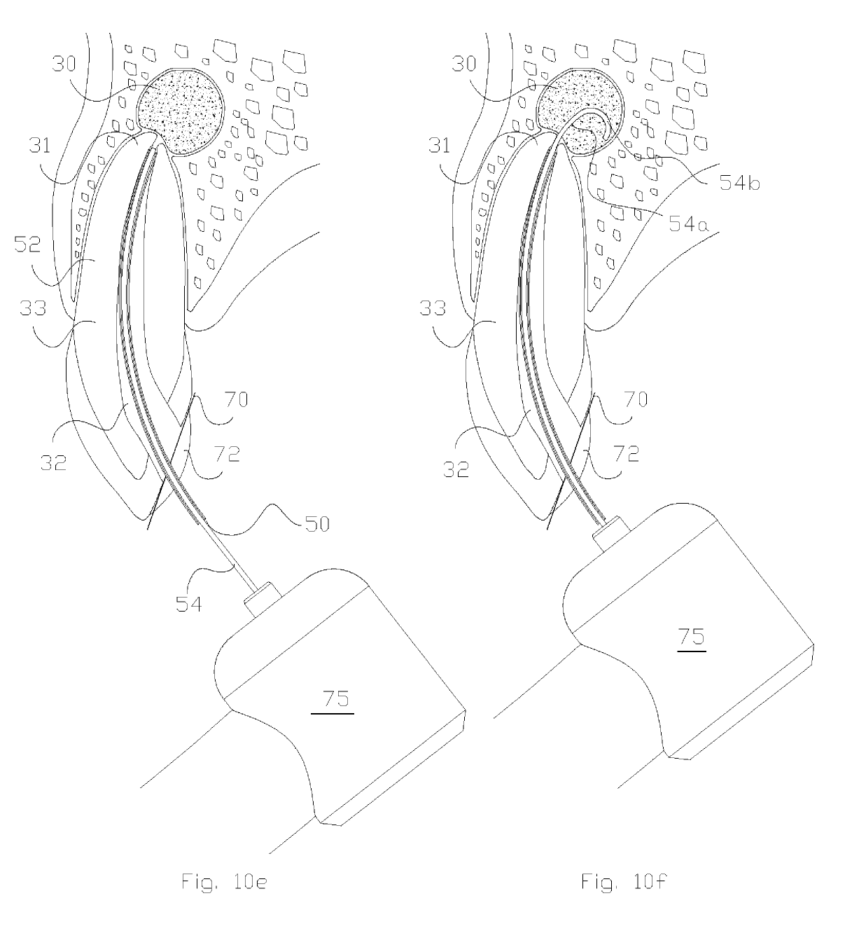

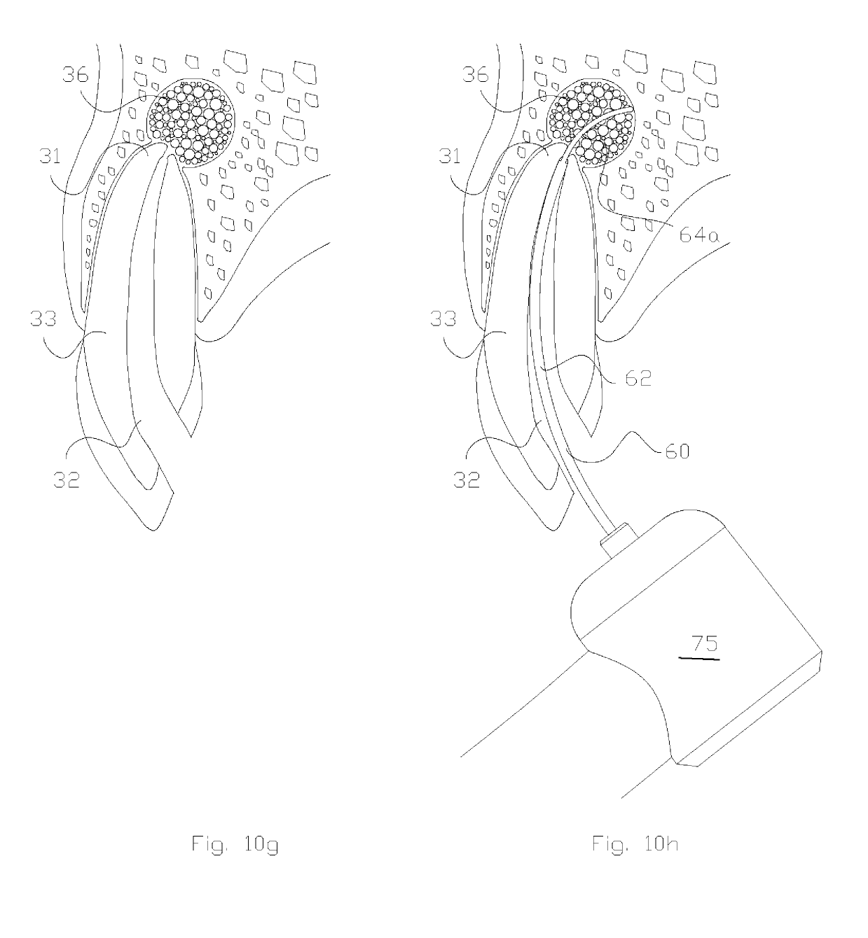

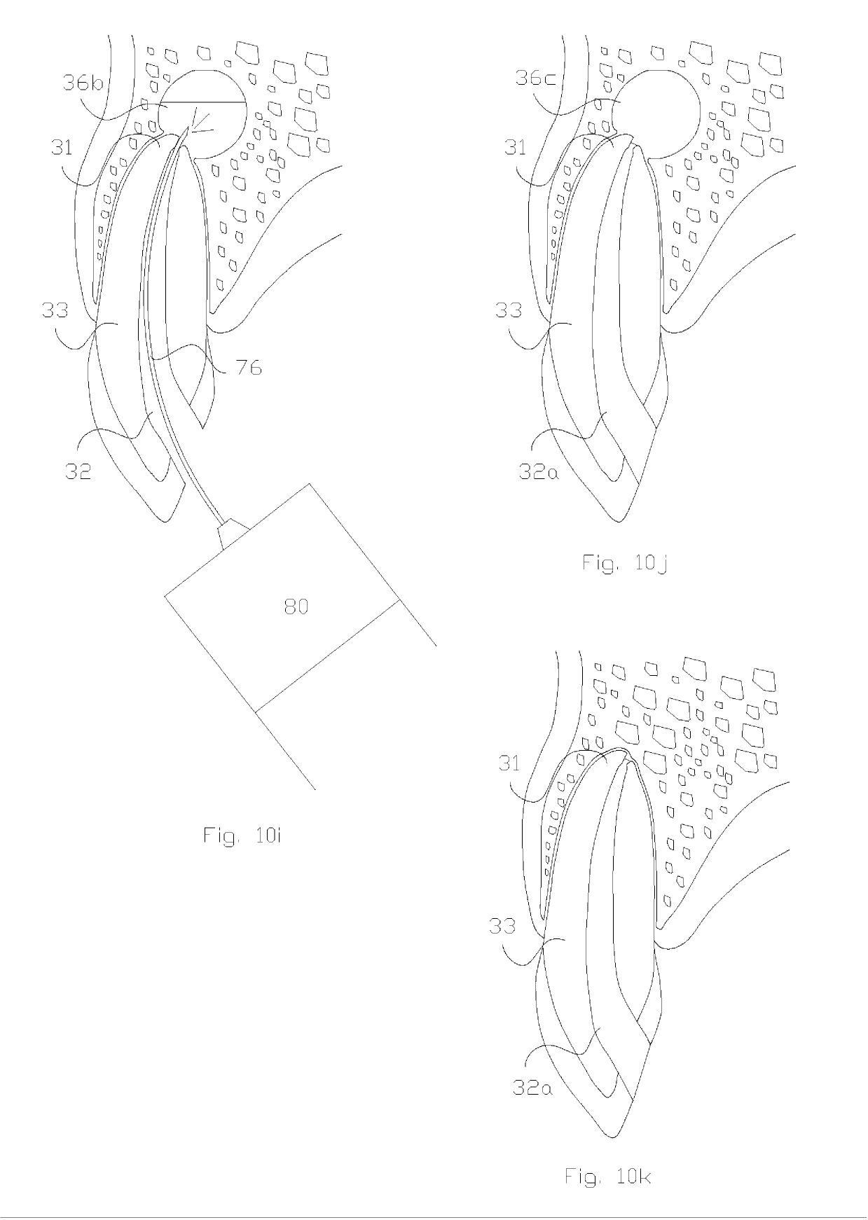

FIGS. 10a-10k illustrate an example of a procedure that may be used, utilizing the metal-filament ablating device 50 of FIGS. 4a-4d (or 50′, of FIGS. 6a-6d), and the polymer-filament ablating device 60 of FIG. 5, for removing a dental periapical lesion in accordance with the present invention. The protective cover 70, described above with respect to FIGS. 8 and 9, is used in the first step of this procedure with the metal-filament ablating device 50 (or 50′) to fix the outer sleeve 52 to the tooth, before deploying the metal filament 54.
1. The root canal 32 of the treated tooth is endodontically prepared by a No. 45 K file 78, to a working length 0.5 mm short of the apical foramen 31. This may preferably be done using a rotary LightSpeed file No. 45. (FIG. 10b) Patency should be established using a No. 25K to 30K file 79 (FIG. 10c). the resulting shape of the apical foramen is stepwise shoulder 38 (FIG. 10d)
2. After rinsing and drying the root canal, ablating device 50 (or 50′), with its Nitinol working filament 54 still contained and hidden within the Nitinol sleeve 52, is inserted to the working length (FIG. 10e).
3. The sleeve is fixed to the tooth and stabilized by placing a protective cover 70 (FIG. 8) over the tooth 71 (FIG. 9), to cover the opening previously formed through its crown leading to the root canal to be treated, and applying a glob of adhesive 74 over the outer surface of the protective cover and the sleeve. A viscous adhesive, such as glass ionomer composite, is used such that it assumes a semi-spherical shape, having a thickness of 1-2 mm at its center, and flows by surface tension in spaces between the radiating tabs 73. The adhesive used may be a settable dental adhesive, e.g., settable by ultraviolet light (FIG. 10e). As indicated earlier, such an arrangement fixes the sheath of the ablating device to the tooth without danger of clogging the root canal with the adhesive.
4. The Nitinol filament 54 is then attached to the speed-controlled contra-angle handpiece 75.
5. While holding the handpiece gently, the user pushes the Nitinol filament 54 through the stabilized sleeve 52 and through the apical foramen into the periapical lesion 30 (FIG. 10f). When the distal curved ends 52a, 52b of Nitinol filament 52 are out of the sleeve, the filament is easily moved back and forth, allowing the operator to know it has emerged from its sleeve.
6. The filament 54 is rotated at a speed of 200-300 rpm while the filament is moved with in and out movements of 1-2 mm, for 30-60 seconds. The extent of the in and out movements can be judged from the distance between the coronal end of the sleeve and the handpiece. A rubber stopper placed on the rotating part may help this judgment.
7. The coronal fixation is then gently removed by breaking off the adhesive, and removing the protective cover from the tooth and the ablating device 50 out of the root canal (FIG. 10g).
8. The root canal may then be rinsed with saline solution or distilled water using a small diameter (30-gauge or thinner) needle, inserted through the apex, such that some of the debris is flushed out with the back-flow.
9. Ablating device 60 (FIGS. 5a-5d) is then measured and its polymer filament 64 is cut to the proper length. Its curved protruding end 64a should be 1-3 mm longer than the estimated diameter of the treated periapical lesion 30.
10. Ablating device 60 is then attached to the handpiece and gently inserted into the root canal, until its metal sleeve 62 reaches the apical stop, while its polymer filament 64 slides through the apical foramen and into the roughly minced periapical lesion 36a (FIG. 10h).
11. Ablating device 60 is then rotated at 15,000-50,000 rpm, for 20-60 seconds, with slight in and out motion, and then taken out of the root canal.
12. The finely minced content of the periapical crypt 36b is then rinsed out with copious amounts of normal saline solution or distilled water, using a 30-32 G needle 76 attached to a syringe 80 (FIG. 10i).
13. The root canal is then dried, using paper points (FIG. 10j), followed by root canal obturation 32a (FIG. 10j).
14. Within several months (2-6), the bone around the bony crypt grows into the empty space 36c, resulting in full recovery (FIG. 10k).

While the invention has been described above with respect to several preferred embodiments, it will be appreciated that these are set forth merely for purposes of example. Thus, as indicated earlier, instead of using rotary ablating devices, other techniques can be used, such as diathermy, liquid nitrogen, ultraviolet light, or laser light, for accessing and removing the dental periapical lesions via the root canal. Many other variations, modifications and applications of the invention will be apparent.

What is claimed is:

1. A method of treating a dental periapical lesion at an apex of a root canal of a tooth, comprising: accessing the dental periapical lesion via said root canal; and
removing the dental periapical lesion via said root canal, wherein said accessing and removing steps are effected by:
(a) passing a rotatable ablating device through an opening formed through the crown of the tooth, root canal, and apex, into engagement with said dental periapical lesion;
(b) rotating said ablating device while in contact with the dental periapical lesion to ablate the dental periapical lesion; and
(c) and removing debris produced by the ablation of the dental periapical lesion via said root canal.

2. The method according to claim 1, wherein said method further comprises reshaping and/or enlarging said apex of the root canal via said opening formed in the tooth.

3. The method according to claim 2, wherein said reshaping and/or enlarging of the apex of the root canal is effected by an endotonic file.

4. The method according to claim 1, wherein said ablating device is of a polymeric material.

5. The method according to claim 1, wherein said ablating device is of a superelastic alloy or a shape-memory alloy.

6. The method according to claim 1, wherein said ablating device is of a biodegradable polymeric material.

7. The method according to claim 1, wherein said accessing and removing steps are effected in a plurality of operations, including an initial operation wherein a metal ablating device is used to mince the periapical lesion, and a subsequent operation wherein a polymeric ablating device is used to remove the minced periapical lesion.

8. The method according to claim 7, wherein said initial operation using a metal ablating device is effected at a rotary speed of less than 1,000 rpm, and said subsequent operation using a polymeric ablating device is effected at a rotary speed of over 1000 rpm.

9. The method according to claim 1, wherein said ablating device includes a filament protruding through one end of a sleeve; said protruding end of the filament being curved outwardly of the longitudinal axis of the filament and sleeve so as to define, when rotated while in contact with the dental periapical lesion, an ablating surface effective to remove the dental periapical lesion.

10. The method according to claim 9, wherein said sleeve is fixed to the tooth before said filament is protruded through one end of the sleeve and rotated.

11. The method according to claim 10, wherein said sleeve is fixed to the tooth before said filament is protruded through one end of the sleeve and rotated, by:
forming an opening in the crown of the tooth leading to said root canal;
placing over said opening in the crown of the tooth a protective cover formed with a plurality of spaced tabs;
applying a flowable, settable adhesive over said protective cover and into the spaces between said tabs;
passing said sleeve of the ablating device, while the filament does not protrude through one end thereof, through said adhesive, plastic cover, crown opening, and root canal, to said periapical lesion at the apex thereof;
and setting said adhesive.

12. The method according to claim 9, wherein the removal of said dental periapical lesion comprises an initial step in which a first said ablating device having a metal filament rotatable at low speed is used to roughly mince the dental periapical lesion, and a subsequent step in which a second said ablating device having a polymeric filament is used to further mince and to remove the dental periapical lesion.

13. The method according to claim 12, wherein the sleeve of said first ablating device is fixed to the tooth before the filament of said first ablating device is rotated.

14. The method according to claim 12, wherein the sleeve of said second ablating device is rotated with said filament of the second ablating device.

15. The method according to claim 12, wherein said first ablating device is rotated at a speed of less than 1,000 rpm, and said second ablating device is rotated at a speed of over 1,000 rpm.

16. The method according to claim 9, wherein said root canal is sealed, after the dental periapical lesion has been removed, by forming a step therein and applying thereto a pre-formed plug.

17. The method according to claim 14, wherein said root canal is sealed, after the dental periapical lesion has been removed, by a root filling material which is permitted to harden.

18. The method according to claim 1, wherein said dental periapical lesion is removed by diathermy, liquid nitrogen, ultraviolet light, or laser light.
